(19) United States
(12) Patent Application Publication
(10) Pub. No.: US 2017/0109660 A1
(43) Pub. Date: Apr. 20, 2017

(54) INFORMATION PROCESSING APPARATUS, INFORMATION PROCESSING METHOD, AND PROGRAM

(71) Applicant: RAKUTEN, INC., Tokyo (JP)

(72) Inventor: Ryohei TAKUMA, Setagaya-ku (JP)

(73) Assignee: Rakuten, Inc., Tokyo (JP)

(21) Appl. No.: 15/128,567

(22) PCT Filed: Mar. 25, 2014
(86) PCT No.: PCT/JP2014/058184

§ 371 Date: Sep. 23, 2016

(51) Int. Cl. G06Q 10/02

(52) U.S. Cl. CPC G06Q 10/02

(57) ABSTRACT

An information processing apparatus includes a communication unit, a storage unit, and a control unit. The communication unit is capable of communicating with a plurality of user terminals. The storage unit stores plan information on a plurality of golf plans, the plurality of golf plans each including a different play condition in a predetermined golf course and being available for reservation. The control unit is capable of controlling the communication unit to send the plan information to one of the plurality of user terminals and accept a reservation for a golf plan selected by a user from the user terminal. Further, the control unit is capable of controlling the storage unit to change play a condition of a different one of the golf plans in the plan information or add a new golf plan to the plan information in accordance with the number of reservations for a predetermined golf plan, the new golf plan including a play condition different from the play conditions of the plurality of golf plans.

### TECHNICAL FIELD

The present invention relates to an information processing apparatus capable of providing services to accept reservations for golf courses on the Internet, an information processing method in the information processing apparatus, and a program.

### BACKGROUND ART

There have been services capable of accepting reservations for golf courses on the Internet in the past.

Patent Document 1 below discloses a golf reservation system, in which a registered member wishing to reserve a golf course views the reservation status of a plurality of golf courses by reading home pages thereof on a network and, via a reservation availability page of the selected golf course, transmits specifications on the date of play, the golf course, the number of users, and a tee time, desired rounds, and other necessary items to a server. The server displays to the member the reservation screen of the golf course involved and shows the content of the reservation such as the date of play and the tee time and, at the same time, requests the entry of the name and membership ID of the person who wishes to make the reservation. The member also puts in the names of those to accompany the member, and then the reservation is confirmed and executed.

Patent Document 1: Japanese Patent Application Laid-open No. 2003-248771

### SUMMARY OF INVENTION

### Problem to be Solved by the Invention

In general, in the golf course reservation service as described above, conditions such as the date of play and the golf course are specified by a user and a search is executed on a reservation site, and thus a list of golf plans that match the conditions is displayed. Content of the golf plans varies and differs depending on a fee and also on whether meals are included or not and whether caddies are included or not, for example.

There are plans having high demand and low demand in a plurality of golf plans for which reservations are available. Therefore, in the system as described in Patent Document 1, reservations are concentrated on the plans having high demand, whereas the number of reservations for the plans having low demand is not increased. As a result, even on the date and time on which the plans can be held in the golf course, the plans cannot be held, and thus benefits are lost.

In view of the circumstances as described above, it is an object of the present invention to provide an information processing apparatus, an information processing method, and a program that are capable of maximizing the number of reservations for golf plans.

### Means for Solving the Problem

To solve the problem described above, according to an embodiment of the present invention, there is provided an information processing apparatus including a communication unit, a storage unit, and a control unit. The communication unit is capable of communicating with a plurality of user terminals. The storage unit stores plan information on a plurality of golf plans, the plurality of golf plans each including a different play condition in a predetermined golf course and being available for reservation. The control unit is capable of controlling the communication unit to send the plan information to one of the plurality of user terminals and accept a reservation for a golf plan selected by a user from the user terminal. Further, the control unit is capable of controlling the storage unit to change a play condition of a different one of the golf plans in the plan information or add a new golf plan to the plan information in accordance with the number of reservations for a predetermined golf plan, the new golf plan including a play condition different from the play conditions of the plurality of golf plans.

The information processing apparatus can thus dynamically change content of an existing golf plan to plan content expected to have high demand, to maximize the number of reservations without carefully examining a plan for maximizing the number of reservations from the beginning of the plan setting.

The predetermined golf plan may include a plurality of tee time slots that are different in tee time. In this case, the control unit may change at least part of the play condition of the different golf plan to be the same as at least part of a play condition of the predetermined golf plan, in a case where a reservation pace of a reserved tee time slot with regard to a total number of the tee time slots of the predetermined golf plan exceeds a predetermined threshold value.

The information processing apparatus can thus consider, in the case where a proportion of the reserved tee time slots is high in a plan, such a plan as a plan having high demand, and change the play condition of the different plan to be closer to the play condition of the plan having high demand, to maximize the number of reservations for all the plans.

The storage unit may store, as the plan information, information on a tentative end date on which acceptance of the reservation for the golf plan is ended and an official end date after the tentative end date, on a golf-plan basis. In this case, the control unit may control the storage unit to extend an end date of the predetermined golf plan in the plan information from the tentative end date to a date between the tentative end date and the official end date, in accordance with the number of reservations for the predetermined golf plan.

The information processing apparatus can thus increase the number of days available for reservation of the plans having high demand in accordance with a reservation acceptance status, to increase the number of reservations.

The storage unit may store information on a first golf plan and a second golf plan, the first golf plan including a first tee time slot as the play condition, the second golf plan including a second tee time slot as the play condition. In this case, the control unit may control the storage unit to change a play condition excluding the second tee time slot of the second golf plan, in accordance with the number of reservations for the first golf plan.

The information processing apparatus can thus change, in the case where the first golf plan is expected to have high demand, the second golf plan having a different tee time slot to have the same play condition as the first plan, for example, to increase the number of reservations for the second golf plan. Here, the first tee time slot and the second tee time slot may be tee time slots on the same date or tee time slots on different dates.

The control unit may control the storage unit to determine whether there is a reservation accepted on a golf-plan basis, set a golf plan for which the reservation is not accepted to be a change target of the play condition, and exclude a golf plan for which the reservation is accepted from the change target of the play condition.

The information processing apparatus can thus exclude a golf plan for which the reservation is already accepted from the change target of the play condition, to prevent the user who has made the reservation from being confused.

The control unit may control the communication unit to determine whether there is a reservation accepted on a golf-plan basis, and send notification information for notifying a change of a play condition of a golf plan for which the reservation is accepted, to one of the user terminals of a user who has made the reservation for the golf plan.

The information processing apparatus can thus notify the user of the change of the play condition of a golf plan for which the reservation is already accepted, to prevent the user who has made the reservation from being confused.

According to another embodiment of the present invention, there is provided an information processing method including: storing plan information on a plurality of golf plans, the plurality of golf plans each including a different play condition in a predetermined golf course and being available for reservation; sending the plan information to one of the plurality of user terminals and accepting a reservation for a golf plan selected by a user from the user terminal; and changing a play condition of a different one of the golf plans in the plan information or adding a new golf plan to the plan information in accordance with the number of reservations for a predetermined golf plan, the new golf plan including a play condition different from the play conditions of the plurality of golf plans.

According to still another embodiment of the present invention, there is provided a program causing an information processing apparatus to execute the steps of: storing plan information on a plurality of golf plans, the plurality of golf plans each including different a play condition in a predetermined golf course and being available for reservation; sending the plan information to one of the plurality of user terminals and accepting a reservation for a golf plan selected by a user from the user terminal; and changing a play condition of a different one of the golf plans in the plan information or adding a new golf plan to the plan information in accordance with the number of reservations for a predetermined golf plan, the new golf plan including a play condition different from the play conditions of the plurality of golf plans.

As described above, according to the present invention, it is possible to dynamically change content of an existing golf plan to plan content expected to have high demand, to maximize the number of reservations without carefully examining a plan for maximizing the number of reservations from the beginning of the plan setting. However, the effects described herein do not necessarily limit the present invention.

### BRIEF DESCRIPTION OF DRAWINGS

FIG. 1 is a diagram showing a configuration of a golf course reservation system according to an embodiment of the present invention.

FIG. 2 is a diagram showing a hardware configuration of a golf course reservation server in the system.

FIG. 3 is a diagram showing a database configuration of the golf course reservation server.

FIG. 4 is a flowchart showing a flow of processing of making a reservation for a golf course by the golf course reservation server.

FIG. 5 is a diagram showing an example of a plan search page, which is generated by the golf course reservation server and displayed in a user terminal.

FIG. 6 is a diagram showing an example of a plan search results page, which is generated by the golf course reservation server and displayed in the user terminal.

FIG. 7 is a diagram showing an example of a plan change notification page, which is generated by the golf course reservation server and displayed in the user terminal.

### MODE(S) FOR CARRYING OUT THE INVENTION

Hereinafter, an embodiment of the present invention will be described with reference to the drawings.

[Configuration of System]

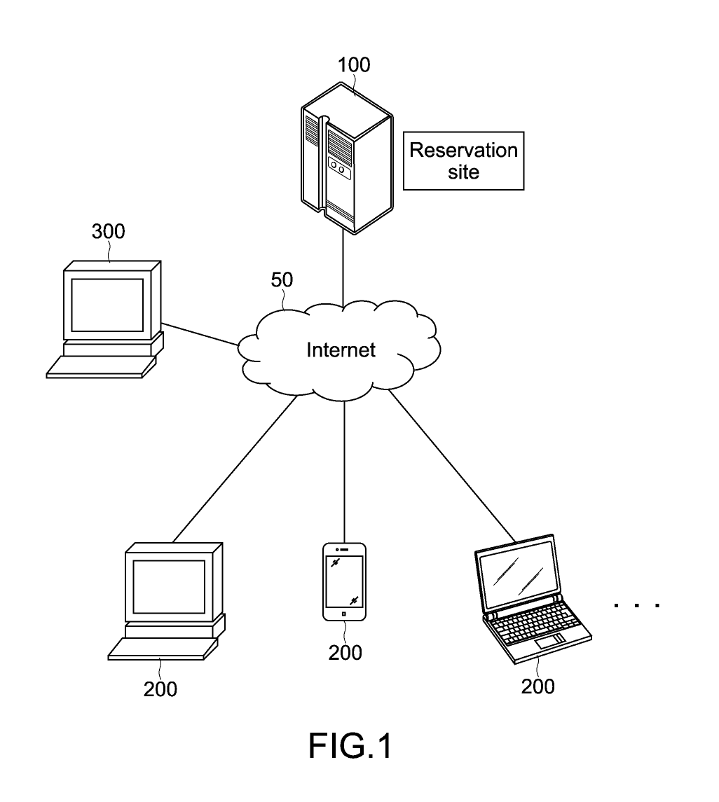

FIG. 1 is a diagram showing a configuration of a golf course reservation system according to this embodiment.

As shown in FIG. 1, the system includes a golf course reservation server 100 on the Internet 50, a plurality of user terminals 200, and a golf course terminal 300.

The golf course reservation server 100 is a server that is managed by a company operating a golf course reservation site. The golf course reservation server 100 is connected to the user terminals 200 and the golf course terminal 300 via the Internet 50.

Each of the user terminals 200 is a terminal used by a user who makes a reservation for a golf course, and is a smartphone, a mobile phone, a tablet PC (Personal Computer), a laptop PC, or a desktop PC, for example.

In response to an access request to the golf course reservation site from each of the user terminals 200, the golf course reservation server 100 generates a web page (HTML (HyperText Markup Language) document) including pieces of golf plan information and the like and sends the web page back to the user terminal 200.

Each of the user terminals 200 accesses the golf course reservation server 100 and receives the web page, to display the web page on a screen by a browser.

The user of the user terminal 200 executes processing of making a reservation for a specific golf plan via the screen displayed by the browser.

The golf course terminal 300 is a terminal device used by persons engaged in golf courses or the like and is a PC, for example. The golf course terminal 300 can access the golf course reservation server 100 to acquire the status of reservations for golf courses of the golf course terminal 300 that are made from the user terminals 200, and the like.

[Hardware Configuration of Golf Course Reservation Server]

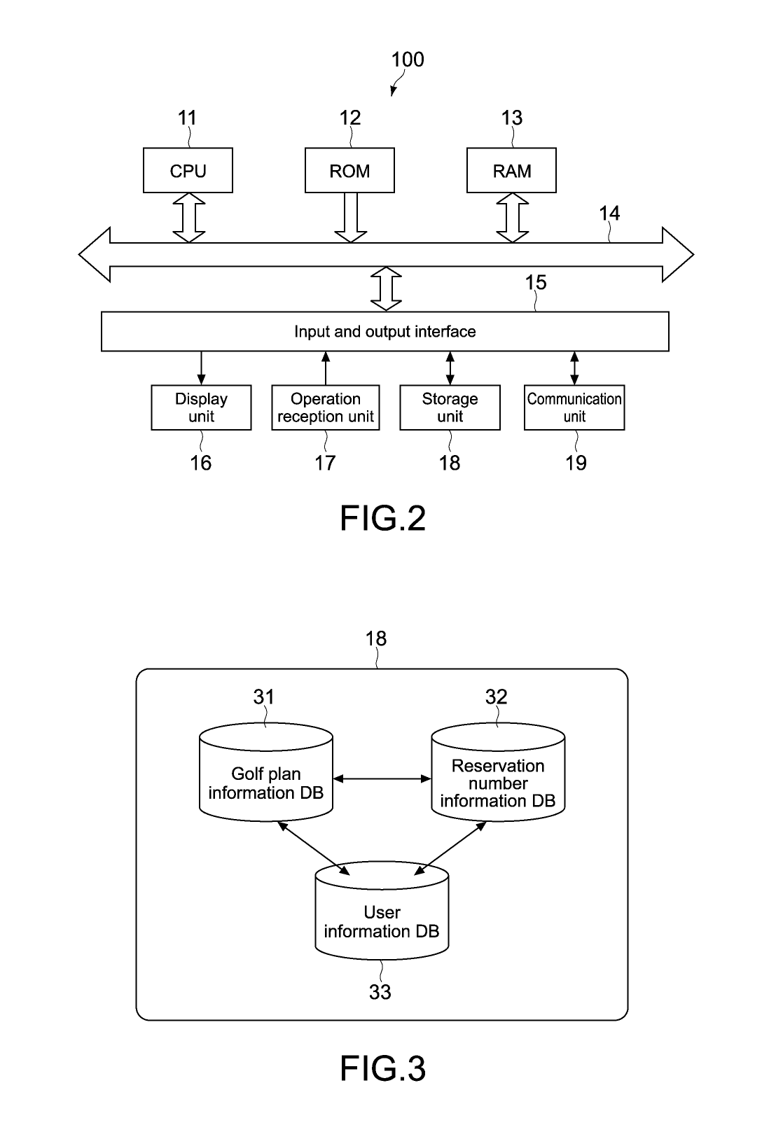

FIG. 2 is a diagram showing a hardware configuration of the golf course reservation server 100. As shown in FIG. 2, the golf course reservation server 100 includes a CPU (Central Processing Unit) 11, a ROM (Read Only Memory) 12, a RAM (Random Access Memory) 13, an input and output interface 15, and a bus 14 that connects those components to one another.

The CPU 11 appropriately accesses the RAM 13 and the like when necessary and performs overall control of the whole blocks of the golf course reservation server 100 while performing various types of computation processing. The ROM 12 is a non-volatile memory in which an OS to be executed by the CPU 11, and firmware such as a program and various parameters are fixedly stored. The RAM 13 is used as a work area or the like of the CPU 11 and temporarily holds the OS, various applications being executed, or various types of data being processed.

A display unit 16, an operation reception unit 17, a storage unit 18, a communication unit 19, and the like are connected to the input and output interface 15.

The display unit 16 is a display device using, for example, an LCD (Liquid Crystal Display), an OELD (Organic Electroluminescence Display), or a CRT (Cathode Ray Tube).

The operation reception unit 17 is an input device, for example, a pointing device such as a mouse, a keyboard, or a touch panel. In the case where the operation reception unit 17 is a touch panel, the touch panel may be integrated with the display unit 16.

The storage unit 18 is a non-volatile memory, for example, an HDD (Hard Disk Drive), a flash memory (SSD; Solid State Drive), or any other solid-state memory. The storage unit 18 stores the OS, various applications, and various types of data.

As will be described later, particularly in this embodiment, the storage unit 18 includes a golf plan information database on golf plans that are available for reservation via a golf course reservation site, a reservation number information database that stores information on the number of reservations for (tee time slots of) golf plans, and a user information database that stores information on users who have made reservations for golf plans.

The communication unit 19 is a NIC (Network Interface Card) for the Ethernet (registered trademark), for example. The communication unit 19 handles processing of communication among the user terminals 200, the golf course reservation server 100, and the golf course terminal 300.

The hardware configuration of the golf course reservation server 100 is similar to that of the golf course reservation server 100, though not shown in the figures.

[Database Configuration of Golf Course Reservation Server]

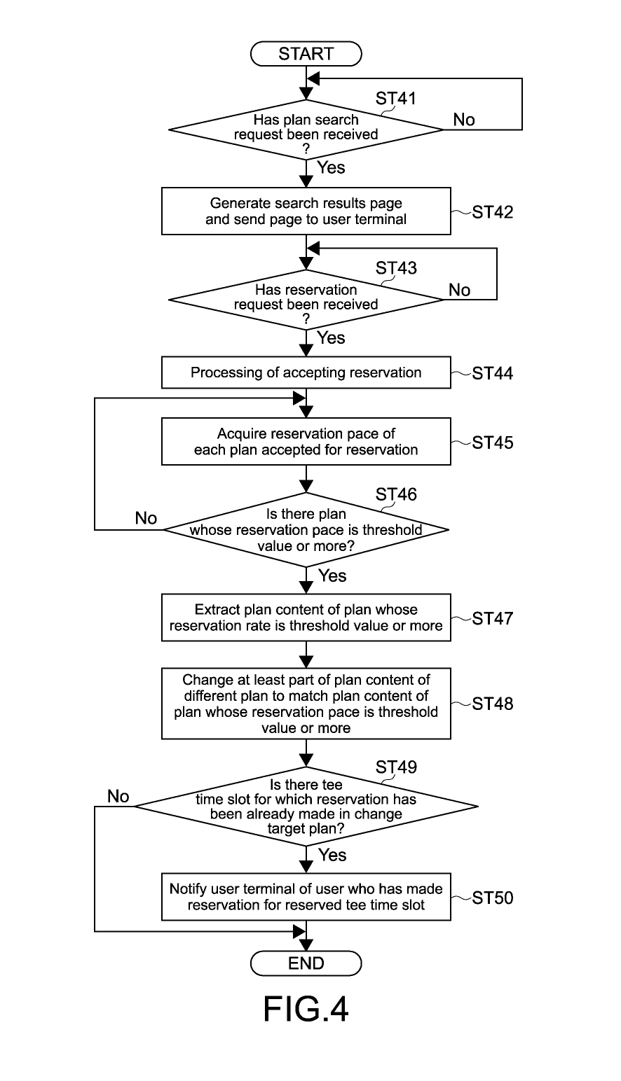

FIG. 4 is a diagram showing a database configuration of the golf course reservation server 100.

As shown in the figure, the golf course reservation server 100 includes a golf plan information database 31, a reservation number information database 32, and a user information database 33 in the storage unit 18.

The golf plan information database 31 stores information on golf plans that are available for reservation in the golf course reservation server 100, specifically, information such as a name of plan, golf course information (name of golf course, location, course information, evaluation, etc.) fee, plan content (with or without meals, with or without caddies, minimum number of users, plan set date, etc.) on a golf-course basis and on a golf-plan basis.

The reservation number information database 32 stores information on the number of reservations for each of the golf plans on a play-slot basis of each plan, the tee time slots being different tee times on the same day of play. Further, the reservation number information database 32 may calculate and store a pace at which reservations for a plurality of tee time slots are made with respect to one plan (hereinafter, reservation pace) as needed.

The user information database 33 stores information on users who have made reservations for the golf plans, specifically, information such as a user's ID, a user's name, a communication destination (e-mail address etc.), and a reservation history.

[Operation of Golf Course Reservation Server]

Next, the operation of the golf course reservation server 100 configured as described above will be described. This operation is executed in cooperation of hardware, such as the CPU 11 and the communication unit 19, and software stored in the storage unit 18, in the golf course reservation server 100. In the following description, the CPU 11 is an actor of the operation for convenience sake.

FIG. 4 is a flowchart showing a flow of processing of making a reservation for a golf course by the golf course reservation server 100.

On reception of a request to display a golf plan search page from the user terminal 200 via the golf course reservation site, the CPU 11 of the golf course reservation server 100 generates a plan search page and sends the plan search page to the user terminal 200, which is not shown in FIG. 4.

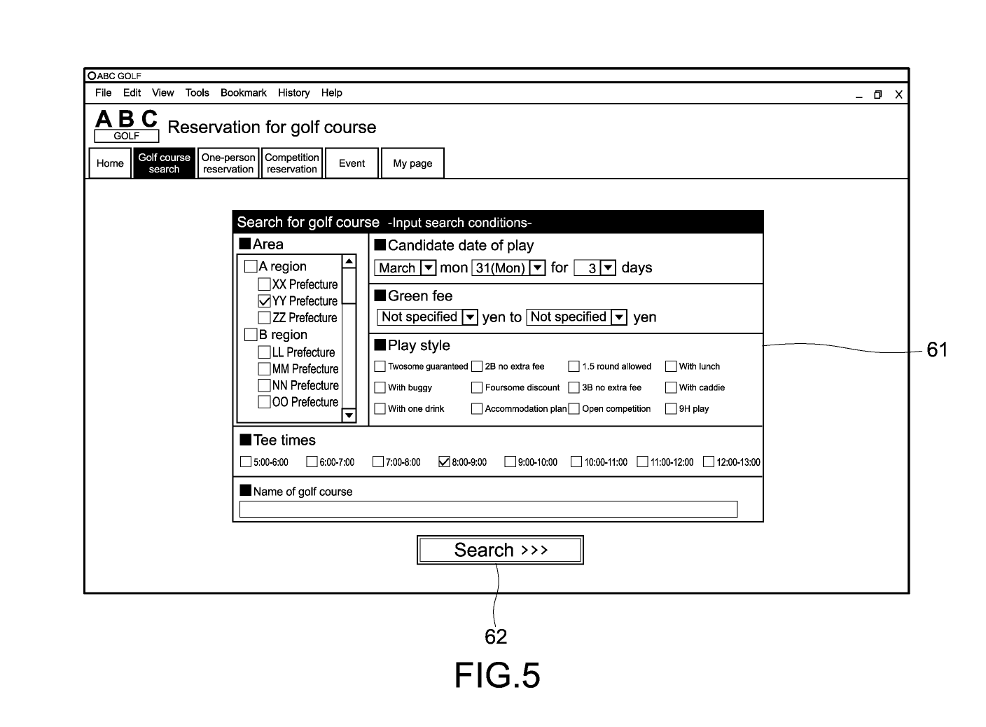

FIG. 5 is a diagram showing an example of a search page generated and displayed in the user terminal 200.

As shown in FIG. 5, the search page includes a search condition setting area 61 in which search conditions such as a tee time and a name of golf course can be set in addition to an area of golf courses available for reservation, the date of play, a green fee, a play style, and a name of golf course, for example. Predetermined conditions are set in the search condition setting area 61, and a search button 62 below the search condition setting area 61 is pressed on the user terminal 200. A search request is thus sent to the golf course reservation server 100.

As shown in FIG. 4, the CPU 11 determines whether a search request via the search page has been received from the user terminal 200 or not (Step 41).

When determining that the search request has been received (Yes), the CPU 11 searches the golf plan information database 31 for a plan that matches the search conditions, generates a search results page showing a list of the search results, and sends the search results page back to the user terminal 200 (Step 42). In the case where there are no plans that match the search conditions, a search results page indicating that there are no plans that match the search conditions is sent back to the user terminal 200.

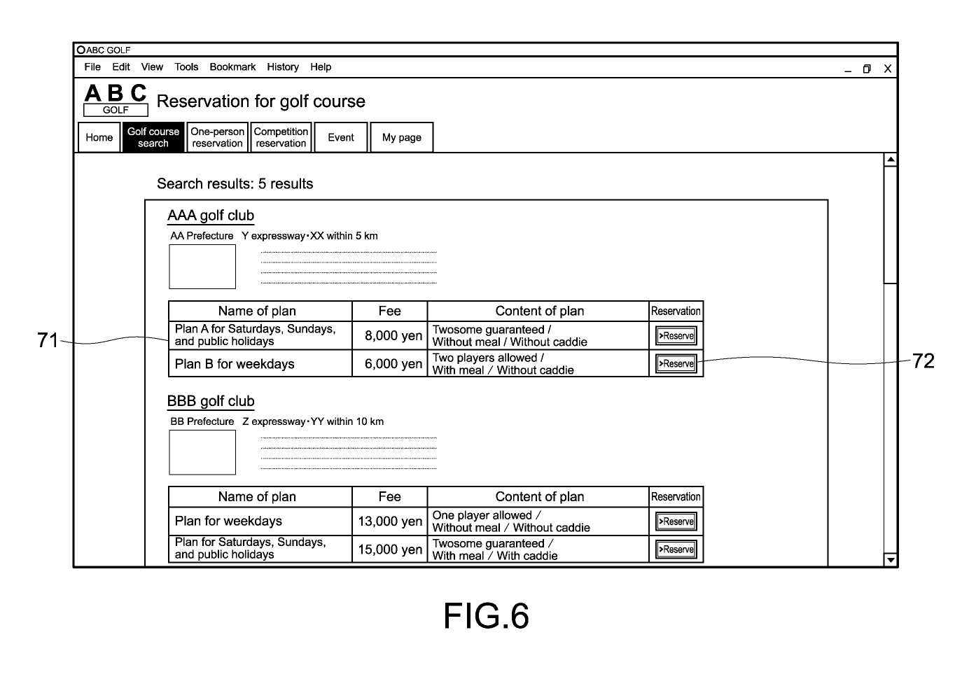

FIG. 6 is a diagram showing an example of a plan search results page, which is generated and displayed in the user terminal 200.

As shown in FIG. 6, the search results page includes a plan list area 71 that matches the search conditions, on a golf-course basis, for example.

A reservation button 72 is provided on, for example, the right end of the plan list area 71. When the reservation button 72 is pressed, the golf course reservation server 100 generates a reservation page for selecting a specific tee time slot (tee time) and the number of users for reservation in the plan, and sends the reservation page to the user terminal 200.

Referring back to FIG. 4, the CPU 11 determines, via the reservation page, whether a reservation request in which the tee time slot and the number of users are selected has been received from the user terminal 200 or not (Step 43).

When determining that the reservation request has been received (Yes), the CPU 11 executes processing of accepting a reservation (Step 44). Specifically, the CPU 11 stores information on a user who has made the reservation, the tee time slot, and the number of users for reservation in the golf plan information database 31 and sets a flag to be ON, the flag indicating whether a reservation for the tee time slot has been made or not. Further, the CPU 11 updates information on the number of reservations and the reservation pace in the golf plan serving as a reservation target, in the reservation number information database 32.

The processing of accepting a reservation described above is executed each time a reservation request is received from the user terminal 200.

Subsequently, the CPU 11 acquires, from the reservation number information database 32, information on a reservation pace on a plan basis, the plan being accepted for reservation (Step 45). This processing may be executed periodically or executed each time the processing of accepting a reservation is executed.

Subsequently, the CPU 11 refers to the acquired reservation pace on a plan basis, and determines whether there is a plan whose reservation pace is a predetermined threshold value or more.

The threshold value may vary on a plan basis, for example, in accordance with the total number of tee time slots of a plan serving as a reservation target. For example, a threshold value in a plan having the larger number of tee time slots is set to be higher than a threshold value in a plan having the smaller number of tee time slots, though both the plans have the same reservation pace. In other words, the threshold value is set in terms of a speed at which reserved tee time slots reach a predetermined proportion with respect to the total number of tee time slots.

When determining that there is a plan whose reservation pace is the threshold value or more (Yes), the CPU 11 acquires, from the golf plan information database 31, information on plan content (play condition) whose reservation pace is the threshold value or more (Step 47).

Subsequently, the CPU 11 changes at least part of plan content (play condition) of a different plan, which has the same golf course as the plan whose reservation pace is the threshold value or more, so as to match the plan content of the plan whose reservation pace is the threshold value or more (Step 48).

For example, in the case where the plan content of a plan whose reservation pace is the threshold value or more includes a meal, and the plan content of a different plan includes no meal, the CPU 11 changes the plan content of the different plan to plan content including a meal. This is because the plan whose reservation pace is the threshold value or more is estimated to have high demand due to including a meal.

In addition, in accordance with the plan content of the plan whose reservation pace is the threshold value or more, such as a fee, including a meal or including no meal, the minimum number of users, and the number of tee time slots, the CPU 11 changes the content of a different plan to be closer to the plan content of the plan whose reservation pace is the threshold value or more. For example, the CPU 11 reduces the fee, changes the plan content without meal to plan content with a meal, reduces the minimum number of users, or increases the number of tee time slots (the number of tee times).

The change target may be one or some of a plurality of elements that configure the plan content. For example, a plan without a meal and without a caddie may be changed to a plan with a meal and with a caddie.

A plan serving as the change target of the plan content may be set on the same date as the plan whose reservation pace is the threshold value or more or may be set on a different date.

The change target of the plan content may be all other plans of a golf course that is the same as the golf course of the plan whose reservation pace is the threshold value or more, or may be some plans randomly selected, for example. Further, only different plans having something in common with the plan whose reservation pace is the threshold value or more, such as plans for Saturdays, Sundays and public holidays, may be set as change targets.

Subsequently, the CPU 11 refers to the golf plan information database 31 to determine whether there is a tee time slot for which a reservation has been already made in the plan serving as the change target (Step 49).

When determining that there is a tee time slot for which a reservation has been already made in the plan serving as the change target (Yes), the CPU 11 notifies the user terminal 200 of a user who has made a reservation for the plan, of the change of the plan content.

For example, in the case where there is a dedicated page (My page) on a login-user basis on the golf course reservation site of the golf course reservation server 100, the CPU 11 may provide a notification for the change of the plan content through the My page. Alternatively, the CPU 11 may send e-mail for providing a notification for the change of the plan content to, for example, an e-mail address of the user without involving the My page.

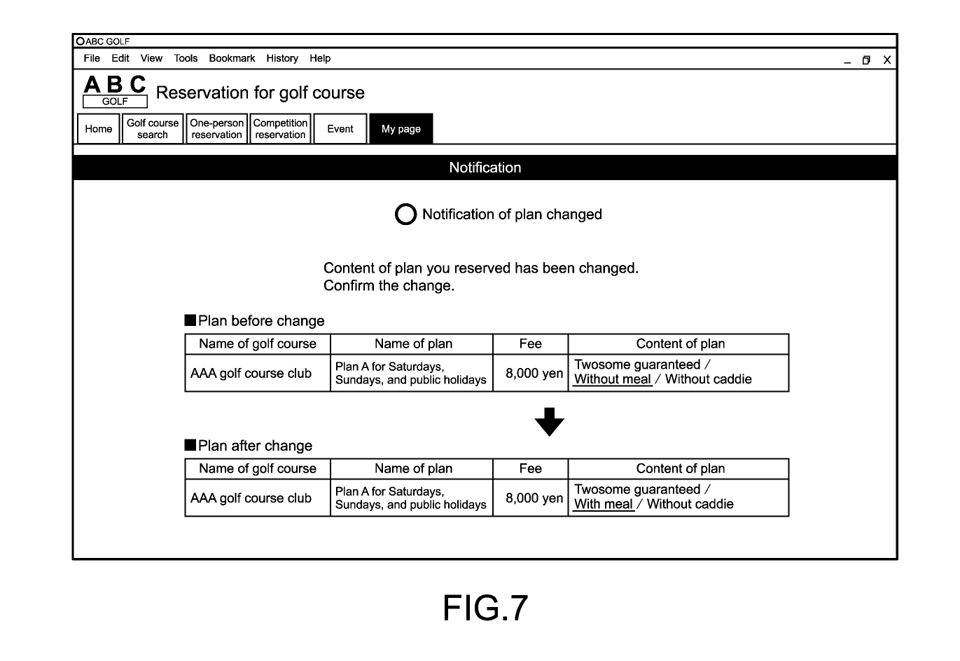

FIG. 7 is a diagram showing an example of a plan change notification page on a My page, which is generated by the golf course reservation server 100 and displayed in the user terminal.

As shown in FIG. 7, for example, the fact that the plan content has been changed is displayed in the My page together with information comparing the plan content before the change and the plan content after the change.

Specifically, FIG. 7 shows an example in the case where, when a reservation pace of a plan B for weekdays is the threshold value or more in two plans for an AAA golf course shown in FIG. 6, the content of the other plan A for Saturdays, Sundays, and public holidays is changed from the plan content without meal to plan content with a meal.

In the case where the user does not have disadvantages by such a change of the plan content (for example, in the case of changing the plan content without meal to plan content with a meal without fee change, and in the case of reducing the fee only), the notification on the change is not indispensable, but the notification can prevent the user from being confused.

In such a manner, according to this embodiment, the golf course reservation server 100 can dynamically change, in accordance with the number of reservations for a certain golf plan (reservation pace), the content of a different golf plan to plan content expected to have high demand, to thus maximize the number of reservations without carefully examining a plan for maximizing the number of reservations from the beginning of the plan setting.

### MODIFIED EXAMPLE

The present invention is not limited to the embodiment described above and can be variously modified without departing from the gist of the present disclosure.

In the embodiment described above, in the case where there is a golf plan whose reservation pace is a threshold value or more, the golf plan content of another golf plan is changed. However, the change target of the plan content is not limited to another golf plan, and may be the same golf plan. In other words, in the cases where the golf course reservation server 100 sets a tentative end date on which the acceptance of reservation is ended on a golf-plan basis, and an official end date after the tentative end date, and where a reservation pace of a certain plan is the threshold value or more, the golf course reservation server 100 may extend the end date of the plan from the tentative end date to a date between the tentative end date and the official end date. The golf course reservation server 100 can thus increase the number of reservations by increasing the number of dates on which reservations for plans having high demand can be accepted, in accordance with a reservation acceptance status.

In the embodiment described above, in the case where there is a golf plan whose reservation pace is a threshold value or more, the golf plan content of another golf plan is changed. However, the plan content of another golf plan is not changed, but a new plan may be added. The new plan shares at least part of the plan content with the golf plan whose reservation pace is the threshold value or more. For example, a new plan having a play condition may be added, the play condition being the same as or similar to that of the golf plan whose reservation pace is the threshold value or more, except for a reservation acceptance period of time. By addition of the new plan, the user can select the new plan in the search results page or the like, and enjoy a benefit thereof.

In the embodiment described above, in the case of changing the plan content of a plan for which reservations have been already made, the golf course reservation server 100 simply provides a notification to a user who has made a reservation for that plan. However, the golf course reservation server 100 may gain agreement with the user by not only providing a notification but also providing an agreement button or the like on the notification page, for example. In the case where the agreement is not gained, the plan content may not be changed, or the changed plan content may be restored. Further, the golf course reservation server 100 may exclude a plan for which reservations have been already made from the change target of the plan content.

In the embodiment described above, in the case where there is a golf plan whose reservation pace is a threshold value or more, the golf plan content of another golf plan is changed. However, in the case where there is a golf plan whose reservation pace is conversely less than the threshold value, the plan content of another golf plan may be changed, or a new golf plan may be added. In other words, the plan content of another plan may be changed so as to increase the demand for the plan, with the presence of not a plan with high demand but a plan with high demand being as a springboard. In this case, the content of a golf plan whose reservation pace is less than the threshold value may also be changed. For example, in the case where there are a plurality of plans for which the same fee is set, when the reservation pace of one of the plans is determined to be low, the fee of that plan may be changed to be lower and the fees of the other plans may also be changed to be lower.

In the embodiment described above, the processing of accepting a reservation is executed from the user terminal 200 via the golf course reservation site. However, the processing of accepting a reservation may be executed when a reservation request is sent to the golf course reservation server 100 via a golf reservation application installed in the user terminal 200.

### DESCRIPTION OF REFERENCE NUMERALS

11 CPU
18 storage unit
19 communication unit
31 golf plan information database
32 reservation number information database
33 user information database
50 Internet
61 search condition setting area
62 search button
71 plan list area
72 reservation button
100 golf course reservation server
200 user terminal
300 golf course terminal

1.-8. (canceled)

9. An information processing apparatus, comprising:
a communication unit configured to communicate with a plurality of user terminals;
a storage unit configured to store plan information on a plurality of golf plans, the plurality of golf plans each including a different play condition in a predetermined golf course and being available for reservation; and
a control unit configured to
send, through the communication unit, the plan information stored in the storage unit to one of the plurality of user terminals accept a reservation for a golf plan selected by a user from the user terminal, and
change a play condition of a different one of the golf plans in the stored plan information or add a new golf plan to the stored plan information in accordance with the number of reservations for a predetermined golf plan, the new golf plan including a play condition different from the play conditions of the plurality of golf plans.

10. The information processing apparatus according to claim 9, wherein
the predetermined golf plan includes a plurality of tee time slots that are different in tee time, and
the control unit changes at least part of the play condition of the different golf plan to be the same as at least part of a play condition of the predetermined golf plan, in a case where a reservation pace of a reserved tee time slot with regard to a total number of the tee time slots of the predetermined golf plan exceeds a predetermined threshold value.

11. The information processing apparatus according to claim 9, wherein
the storage unit stores, as the plan information, information on a tentative end date on which acceptance of the reservation for the golf plan is ended and an official end date after the tentative end date, on a golf-plan basis, and
the control unit extends an end date of the predetermined golf plan in the stored plan information from the tentative end date to a date between a day after the tentative end date and the official end date, in accordance with the number of reservations for the predetermined golf plan.

12. The information processing apparatus according to claim 9, wherein
the storage unit stores information on a first golf plan and a second golf plan, the first golf plan including a first tee time slot as the play condition, the second golf plan including a second tee time slot as the play condition, and
the control unit changes a play condition excluding the second tee time slot of the stored second golf plan, in accordance with the number of reservations for the stored first golf plan.

13. The information processing apparatus according to claim 9, wherein
the control unit determines whether there is a reservation accepted on a golf-plan basis, sets a golf plan for which the reservation is not accepted to be a change target of the stored play condition, and excludes a golf plan for which the reservation is accepted from the change target of the stored play condition.

14. The information processing apparatus according to claim 9, wherein
the control unit determines whether there is a reservation accepted on a golf-plan basis, and sends, through the communication unit, notification information for notifying a change of a play condition of a golf plan for which the reservation is accepted, to one of the user terminals of a user who has made the reservation for the golf plan.

15. An information processing method, comprising:
storing plan information on a plurality of golf plans, the plurality of golf plans each including a different play condition in a predetermined golf course and being available for reservation;
sending the plan information to one of the plurality of user terminals and accepting a reservation for a golf plan selected by a user from the user terminal; and
changing a play condition of a different one of the golf plans in the plan information or adding a new golf plan to the plan information in accordance with the number of reservations for a predetermined golf plan, the new golf plan including a play condition different from the play conditions of the plurality of golf plans.

16. The information processing method according to claim 15, wherein
the predetermined golf plan includes a plurality of tee time slots that are different in tee time, and
the information processing method further comprises changing at least part of the play condition of the different golf plan to be the same as at least part of a play condition of the predetermined golf plan, in a case where a reservation pace of a reserved tee time slot with regard to a total number of the tee time slots of the predetermined golf plan exceeds a predetermined threshold value.

17. The information processing method according to claim 15, further comprising:
storing, as the plan information, information on a tentative end date on which acceptance of the reservation for the golf plan is ended and an official end date after the tentative end date, on a golf-plan basis; and
extending an end date of the predetermined golf plan in the stored plan information from the tentative end date to a date between a day after the tentative end date and the official end date, in accordance with the number of reservations for the predetermined golf plan.

18. The information processing method according to claim 15, further comprising:
storing information on a first golf plan and a second golf plan, the first golf plan including a first tee time slot as the play condition, the second golf plan including a second tee time slot as the play condition; and
changing play a condition excluding the second tee time slot of the stored second golf plan, in accordance with the number of reservations for the stored first golf plan.

19. The information processing method according to claim 15, further comprising
determining whether there is a reservation accepted on a golf-plan basis, sets a golf plan for which the reservation is not accepted to be a change target of the stored play condition, and excludes a golf plan for which the reservation is accepted from the change target of the stored play condition.

20. The information processing method according to claim 15, further comprising
determining whether there is a reservation accepted on a golf-plan basis, and sends, through a communication unit, notification information for notifying a change of a play condition of a golf plan for which the reservation is accepted, to one of the user terminals of a user who has made the reservation for the golf plan.
